(19) United States
(12) Patent Application Publication
(10) Pub. No.: US 2020/0063967 A1
(43) Pub. Date: Feb. 27, 2020

(54) ANNULAR COMBUSTION CHAMBER WITH CONTINUOUS DETONATION WAVE

(71) Applicant: SAFRAN, Paris (FR)

(72) Inventors: Matthieu LEYKO, Moissy-Cramayel Cedex (FR); Michel Pierre CAZALENS, Moissy-Cramayel Cedex (FR)

(73) Assignee: SAFRAN, Paris (FR)

(21) Appl. No.: 16/097,732

(22) PCT Filed: May 22, 2017
(86) PCT No.: PCT/FR2017/051252

§ 371 Date: Oct. 30, 2018

(30) Foreign Application Priority Data
May 23, 2016 (FR) 1654570

(51) Int. Cl. F23R 7/00; F02K 7/04

(52) U.S. Cl. CPC F23R 7/00; F05D 2260/99; F05D 2240/35; F02K 7/04

(57) ABSTRACT

An annular combustion chamber of the continuous detonation wave type enabling a mixture of a fuel and an oxidizer injected in an axial direction F to be used to deliver continuous production of hot gas from detonation waves, the combustion chamber including electrodes powered by an electricity generator and between which NRP electric discharges are generated, the combustion chamber including at the upstream ends of its outer and inner walls, a plurality of electrode pairs angularly distributed in two concentric rings, the electrodes of a pair each belonging to a different ring and being in radial alignment, and the electricity generator being configured to power at least one electrode pair to generate at least one discharge zone, and to power sequentially each of the electrode pairs following to the electrode pair and enable a detonation wave to travel around the annular combustion chamber.

### BACKGROUND OF THE INVENTION

The invention relates to a system of combustion by plasma assisted continuous detonation.

In order to reduce significantly the specific consumption of a gas turbine aeroengine (turboshaft engine, turbofan, turboprop, etc. . . . ), it is appropriate to modify its thermodynamic cycle.

Conventional gas turbines operate with the Brayton cycle in which combustion takes place at constant pressure (isobaric) and under deflagration conditions (the combustion front propagates via molecular and thermal diffusion). In order to enable an improvement of 10% to 20% in the thermal efficiency of a machine, it is known to have recourse to combustion under detonation conditions (the combustion front propagates via coupling between a shock wave and the chemical reaction zone). The scientific community usually cites Fickett & Jacobs for the thermodynamic cycle associated with this mode of combustion.

At present, several solutions exist for obtaining detonation conditions in a combustion chamber.

A first solution known under the name of a pulse detonation engine (PDE) consists in initiating detonation periodically after filling the combustion chamber with a detonating mixture. After detonation, the burnt gas needs to be purged and the cycle restarts. The drawback with that solution is that it is necessary to trigger detonation for each cycle, and to do so at frequencies of about 100 hertz (Hz). In that solution, the ignition system is the critical element (for reasons of size, reliability, etc.) and it is necessary to have a gating system upstream from the combustion chamber.

Another solution, which corrects in part the drawback of the first, consists in initiating detonation once only, and then in sustaining a standing or rotating detonation wave. Under such circumstances, a detonating mixture is injected axially into an annular combustion chamber, and the detonation wave propagates circumferentially. Known as a rotating detonation engine (RDE) the advantage of that system for anaerobic propulsion (rocket engine) is now accepted by the scientific community. In contrast, that technological solution is not unanimously accepted concerning use for aerobic propulsion (turbine engine or ramjet), i.e. for a mixture of fuel and air, in which the proportion of oxygen is low compared with nitrogen. When using liquid kerosene with air, the reactive mixture is “difficult” to cause to detonate or even to sustain detonation under ideal conditions once established in a combustion chamber.

Proposals have also been made in patent EP 2 480 771 (or application US 2012/0151898) for a combustion chamber structure in which the detonation wave is sustained by generating a transient plasma. Nevertheless, that structure still presents certain drawbacks such as the need for a large amount of energy because of the non-localized deposition of the plasma or chaotic initiation of the detonation, and in particular it still requires recourse to an even more complex initiator system in order to detonate the mixture a first time.

### OBJECT AND SUMMARY OF THE INVENTION

A main object of the present invention is thus to propose a technical solution seeking to correct that defect.

This object is achieved by an annular combustion chamber of the continuous detonation wave type enabling a mixture of a fuel and an oxidizer injected in an axial direction F to be used to deliver continuous production of hot gas from detonation waves, the combustion chamber comprising a plurality of electrode pairs that are angularly distributed in uniform manner in two concentric rings, the two electrodes of a given pair each belonging to a different ring and being in radial alignment, and an electricity generator controlled by a control device to generate NRP electric discharges in succession between said plurality of electrode pairs, said electricity generator being configured to power at least a first pair of electrodes electrically so as to generate at least one first discharge zone and then sequentially, to power one after another, each of said following electrode pairs, thereby enabling a detonation wave to travel continuously around said annular combustion chamber.

Thus, by creating a rotating plasma curtain, detonation can be initiated simply without having recourse to the complex systems of the prior art.

Preferably, said plurality of electrodes is arranged at the respective upstream ends of outer and inner walls of said annular combustion chamber.

Advantageously, said electricity generator is configured to power each of said electrode pairs preceding at least one detonation front of said detonation wave.

Preferably, in order to power each of said electrode pairs one after another, said electricity generator is configured to stop powering said at least one electrode pair when said at least one adjacent electrode pair is to be powered.

Advantageously, each of said electrodes presents a T-shaped section with a first conductive portion forming a plate flush with the inside surface of said annular combustion chamber and a second conductive portion perpendicular to the first portion, in electrical contact therewith, and extending radially transversely to said annular combustion chamber in order to provide an electrical connection between said conductive plate and said electricity generator.

Preferably, two conductive plates of two adjacent electrodes are spaced apart by a distance of the order of no more than a few millimeters.

Advantageously, said electrodes and said annular combustion chamber are spaced apart by a layer of (advantageously ceramic) insulating material for electrically insulating said electrodes from the structure of the annular combustion chamber.

Preferably, each ring comprises a number of electrodes lying in the range eight to sixty-four.

The invention also provides a turbine engine including an annular combustion chamber as specified above.

### BRIEF DESCRIPTION OF THE DRAWINGS

Other characteristics and advantages of the present invention appear from the following description made with reference to the accompanying drawings, which show an embodiment having no limiting character, and in which:

FIG. 1 is an outside view of the upstream portion of an annular combustion chamber of the invention;

FIG. 2 is a front view of the FIG. 1 annular combustion chamber showing the system for generating and assisting detonation;

FIGS. 3A to 3C show three embodiments of the system for generating and assisting detonation;

FIG. 4 shows a detail of the FIG. 1 annular combustion chamber; and

FIGS. 5A to SD show different stages in the operation of the annular combustion chamber of the invention.

### DETAILED DESCRIPTION OF AN EMBODIMENT

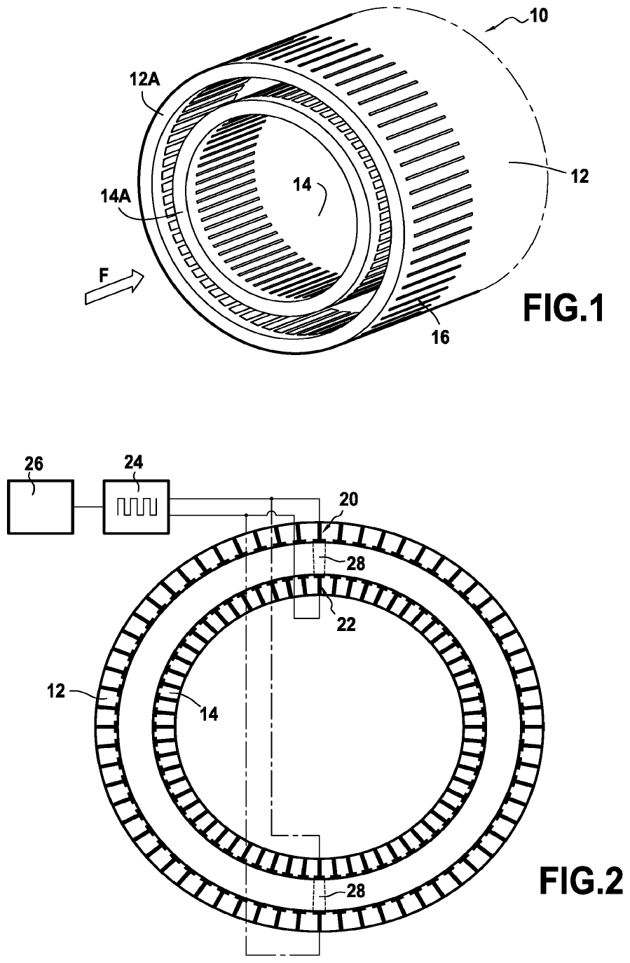

FIG. 1 is a diagram showing part of an annular combustion chamber 10 of the continuous detonation wave type that is defined by an outer wall 12 and an inner wall 14 and that is to receive axially a subsonic reactive mixture (an association of a fuel such as a gaseous or liquid hydrocarbon together with an oxidizer such as air or oxygen) so as to act, in accordance with the invention, to generate a continuous detonation wave and cause it to propagate circumferentially in the annular combustion chamber.

For this purpose, the annular combustion chamber includes plasma generator means 16 in its upstream portion as shown (where “upstream” is relative to the stream F of mixture passing axially through the chamber), which means are located as close as possible to the upstream ends 12A and 14A respectively of the inner and outer walls of the annular combustion chamber 10.

FIG. 2 is a diagrammatic front view showing an example of how the plasma generator means 16 are installed at the respective upstream ends 12A and 14A of the inner and outer walls of the annular combustion chamber, which means are constituted by a set of electrode pairs 20, 22 forming two concentric rings. Each of the two electrodes of a given pair belongs to a different ring and a discharge zone 28 is to be generated between them by means of an electricity generator 24 connected to the two electrodes and controlled by a control device 26. The discharge zone 28 generates a “plasma” in the mixture flowing between these two electrodes, the electrodes of each pair are arranged facing each other, and the electrode pairs are angularly distributed in uniform manner around the circumference of these two upstream ends.

The electricity generator 24 is conventionally a solid state generator delivering electrical pulses having an amplitude in the range 5 kilovolts (kV) to 50 kV (typically 30 kV), a frequency in the range 10 kilohertz (kHz) to 100 kHz (typically 50 kHz), and a duration lying in the range 10 nanoseconds (ns) to 30 ns (typically 20 ns) serving to create nanosecond repetitive pulses (NRPs) between the two electrodes, which are spaced apart by a distance lying in the range 2 millimeters (mm) to 100 mm (typically 20 mm) and through which a subsonic reactive mixture passes.

The control device 26 may be a controller specially dedicated to this function of plasma generation, or more generally it may be incorporated in the control electronics of the engine and thus make use of information concerning temperature or pressure measured in real time in the combustion chamber. This information may be associated with optical measurements taken in the combustion chamber and serving to detect potential extinction of the detonation.

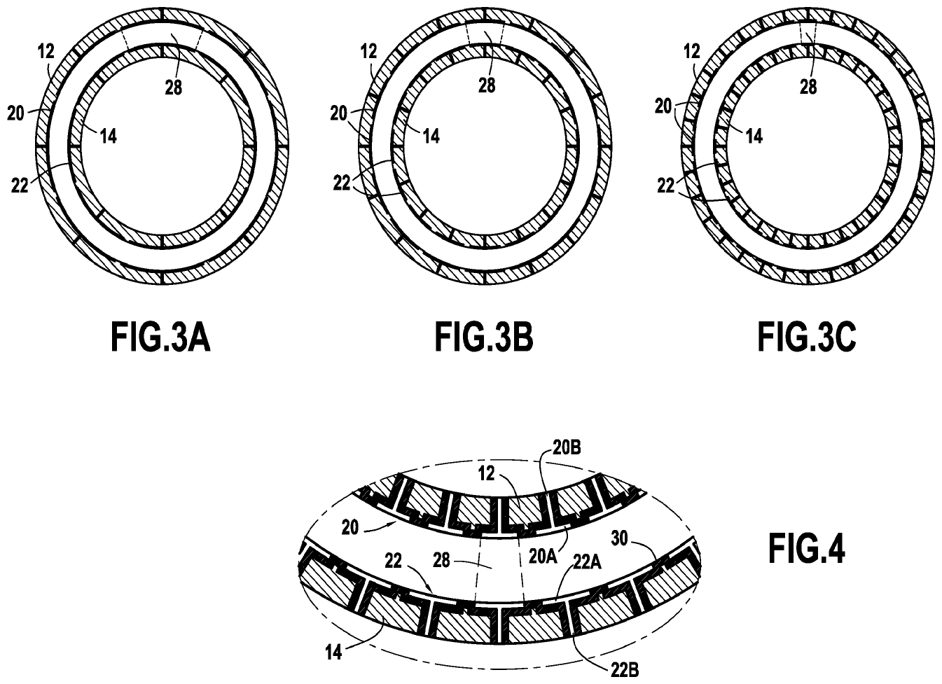

Although in the embodiment shown in FIG. 2, the combustion chamber has sixty-four pairs of electrodes 20, 22, it should be observed that it is clear that this number is not limiting and could in particular be smaller, e.g. eight pairs (FIG. 3A), sixteen pairs (FIG. 3B), or indeed thirty-two pairs (FIG. 3C), depending on the electrical energy that is available. A greater number of electrodes corresponding to smaller sector discharge zones 28 provides finer control over the rotation of the detonation front and requires less electrical energy for optionally obtaining the same result, but nevertheless to the detriment of a control device that is more complex to implement.

As shown in the detail of FIG. 4, in the outer wall 12 of the combustion chamber and also in its inner wall 14, each electrode 20, 22 advantageously presents a T-shaped section with a first conductive portion 20A, 22A forming a plate that is flush with the inside surface of the combustion chamber, and with a second conductive portion 20B, 22B perpendicular to the first and electrically in contact therewith, passing radially transversely relative to the combustion chamber and intended to act via electric connection wires (not shown) to provide electrical connection between the conductive plate and the electricity generator 24 in order to create the discharge zone 28.

Depending on the number of electrodes, the discharge zone 28 covers a greater or lesser angular sector of the combustion chamber, and the conductive plate 20A, 22A thus presents a form going from substantially horizontal (for sixty-four pairs or more) to greatly curved (for eight pairs or fewer). Nevertheless, regardless of the number of electrodes, the distance between the two conductive plates of two adjacent electrodes is always identical and remains of the order of no more than a few millimeters in order to facilitate the passage (rotation) of the detonation front from one pair of electrodes to another.

The electrodes are advantageously made of metal and the combustion chamber is advantageously made of composite material, preferably being separated by a layer 30 of insulating material, and advantageously of ceramic material, in order to insulate the T-shaped electrode electrically from the composite structure of the combustion chamber.

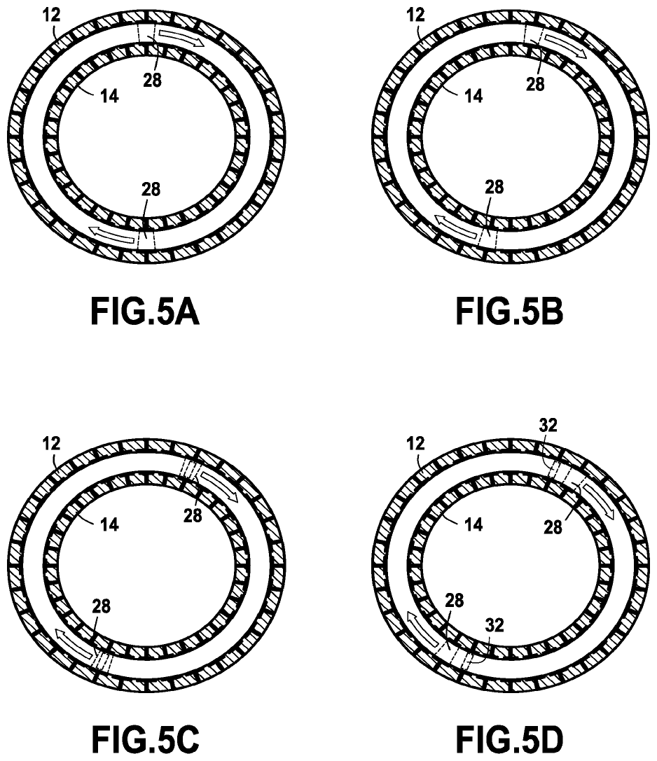

With reference to FIGS. 5A to 5D, there follows a description of the operation of the combustion chamber.

Firstly, it is necessary to ignite the combustion chamber, which consists in causing the mixture to detonate a first time, i.e. to initiate one or more detonation fronts 32 by generating “turning” discharge zones 28 by using the electricity generator to apply electrical pulses sequentially to each of the pairs of electrodes so as to create a succession of NRP discharges (FIG. 5A shows by way of example the first two discharges that are generated simultaneously and diametrically opposite each other in the annular chamber, and FIG. 5B shows the two second discharges between the two adjacent pairs of electrodes) that encourage detonation during the passage of the shock wave through the reactive mixture and that enable a detonation wave to travel continuously around the annular chamber (FIG. 5C). The simultaneous “rotation” of the two discharge zones (illustrated by the arrow) resulting from successive switching of the power supply from one pair of electrodes to another (the power supply to the preceding pair being disconnected as a result of this switching) can be qualified as “discrete” since it corresponds merely to applying the electric signal successively to different pairs of electrodes. The purpose of creating plasma in the detonation zone is to reduce the activation energy and in particular to avoid decoupling between the shock wave and the reaction front that follows the shock.

By applying new electrical pulses to the pair(s) of electrodes arranged immediately in front of the detonation front (FIG. 5D), a new discharge zone 28 is generated followed by more discharge zones, as the front advances, by performing the same actions one after another for each of the following pairs of electrodes so as always to keep in ahead of the detonation front(s) 32. The discharge zone thus “prepares” detonation/combustion, and when the front approaches the discharge zone, the electrical signal is applied to the following pair of electrodes (with the power supply to the preceding pair then being disconnected). Thus, the succession of electrical discharges between the electrodes sustain the detonation front 32 in the combustion chamber.

Using the principle of NRP discharges, combustion of a high activation energy mixture is enhanced. This is due in particular to the fact that the method both generates atomic oxygen (O₂→20), which encourages chemical reaction, and secondly also forms H₂, which also accelerates combustion. In particular, there can be observed an improvement in the stability of the flame and an extension of the lean extinction limit. The advantage of the invention applied to aerobic propulsion is that it is possible to initiate and “assist” detonation by NRP discharges for a mixture of air and liquid kerosene for which the ability to detonate is not guaranteed, a priori.

1-10 (cancelled)

11. An annular combustion chamber of the continuous detonation wave type enabling a mixture of a fuel and an oxidizer injected in an axial direction F to be used to deliver continuous production of hot gas from detonation waves, the combustion chamber comprising:
a plurality of electrode pairs that are angularly distributed in uniform manner in two concentric rings, the two electrodes of a given pair each belonging to a different ring and being in radial alignment; and
an electricity generator controlled by a control device to generate NRP electric discharges in succession between said plurality of electrode pairs, said electricity generator being configured to power at least a first pair of electrodes electrically so as to generate at least one first discharge zone and then sequentially, to power one after another, each of said following electrode pairs of said rings, thereby enabling a detonation wave to travel continuously around said annular combustion chamber.

12. The annular combustion chamber according to claim 11, wherein said plurality of electrodes is arranged at the respective upstream ends of outer and inner walls of said annular combustion chamber.

13. The annular combustion chamber according to claim 11, wherein said electricity generator is configured to power each of said electrode pairs preceding at least one detonation front of said detonation wave.

14. The annular combustion chamber according to claim 11, wherein, in order to power each of said electrode pairs one after another, said electricity generator is configured to stop powering said at least one electrode pair when said at least one adjacent electrode pair is to be powered.

15. The annular combustion chamber according to claim 11, wherein said electrodes presents a T-shaped section with a first conductive portion forming a plate flush with the inside surface of said annular combustion chamber and a second conductive portion perpendicular to the first portion, in electrical contact therewith, and extending radially transversely to said annular combustion chamber in order to provide an electrical connection between said conductive plate and said electricity generator.

16. The annular combustion chamber according to claim 15, wherein two conductive plates of two adjacent electrodes are spaced apart by a distance of the order of no more than a few millimeters.

17. The annular combustion chamber according to claim 15, wherein said electrodes and said annular combustion chamber are spaced apart by a layer of insulating material for electrically insulating said electrodes from the structure of the annular combustion chamber.

18. The annular combustion chamber according to claim 17, wherein said electrically insulating material is a ceramic material.

19. The annular combustion chamber according to claim 11, wherein each ring comprises a number of electrodes lying in the range eight to sixty-four.

20. A turbine engine including an annular combustion chamber according to claim 11.
